(19) United States
(12) Patent Application Publication
(10) Pub. No.: US 2017/0028835 A1
(43) Pub. Date: Feb. 2, 2017

(54) Electric Vehicle

(71) Applicant: William Worley, Andalusia, AL (US)

(72) Inventor: William Worley, Andalusia, AL (US)

(21) Appl. No.: 15/224,090

(22) Filed: Jul. 29, 2016

Related U.S. Application Data
(60) Provisional application No. 62/198,277, filed on Jul. 29, 2015.

(51) Int. Cl. B60K 6/26; B60K 1/04; B60L 8/00; B60K 16/00

(52) U.S. Cl. CPC B60K 6/26; B60K 16/00; B60K 1/04; B60L 8/003; B60K 2016/003; B60K 2001/0405

(57) ABSTRACT

A vehicle configured to operate independently from fossil fuel power sources. The vehicle includes a battery, a solar cell, and an electric motor operably connected to the internal combustion engine. The vehicle includes multiple supplemental power sources, including wheel induction generators and the inertial generators, configured to recapture of the portion expended to operate the vehicle, reducing the amount of electrical energy required to be generated by the solar cell. Each of the induction generators includes an induction coil and a plurality of magnets positioned about each of the hubs of the wheels. Rotation of the plurality of magnets about the induction coil from when the vehicle is in motion generates an electrical current in the induction coil. The inertial generators can be directly connected to the electric motor or in electrical communication with the battery.

### CROSS REFERENCE TO RELATED APPLICATIONS

This application claims the benefit of U.S. Provisional Application No. 62/198,277 filed on Jul. 29, 2015. The above identified patent application is herein incorporated by reference in its entirety to provide continuity of disclosure.

### BACKGROUND OF THE INVENTION

The present invention relates to electric vehicles. More specifically, the present invention relates to vehicles that are configured to operate without the need for fossil fuels.

Modern society has an incredible reliance upon fossil fuels largely because automobiles require them to operate. Such a reliance on fossil fuels causes damage to the environment and makes large industries, such as the trucking industry, highly sensitive to changes in the fossil fuel prices. With regards to the trucking industry, most semi-trailer trucks have diesel engines, which generate an extensive amount of emissions when the truck is traveling over long distances. Therefore, an all-electric vehicle that solely utilized solar energy and energy recaptured from the standard operation of the vehicle in an efficient manner would be a great boon to the trucking industry in reducing sensitivity to market fluctuations and reducing the amount of pollutants generated.

### SUMMARY OF THE INVENTION

In view of the foregoing disadvantages inherent in the known types of electric vehicles now present in the prior art, the present invention provides an electric vehicle that operates completely independently from fossil fuels. The present electric vehicle includes a battery, a solar cell disposed on an exterior of the vehicle, wherein the solar cell in electrical communication with the battery. The vehicle further includes one or more induction generators disposed at one or more wheels of the electric vehicle, the one or more induction generators each including an induction coil and a plurality of magnets disposed about a wheel hub of each of the one or more wheels. Rotation of the plurality of magnets about the induction coil is configured to generate an electrical current in the induction coil. Each of the one or more induction generators is in electrical communication with the battery. The vehicle further includes an electric motor operably connected to an internal combustion engine, the electrical motor in electrical communication with the battery and drawing electrical energy therefrom for the operation of the internal combustion engine. The vehicle still further includes a first inertial generator in direct electrical communication with the electric motor and a second inertial generator in electrical communication with the battery.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a diagram of an embodiment of the present electric vehicle.

FIG. 2 shows a sectional view of an embodiment of an induction generator of the present electric vehicle.

FIG. 3 shows a lateral view of an embodiment of an induction generator of the present electric vehicle.

### DETAILED DESCRIPTION OF THE INVENTION

Reference is made herein to the attached drawings. Like reference numerals are used throughout the drawings to depict like or similar elements of the present electric vehicle. The figures are intended for representative purposes only and should not be considered to be limiting in any respect.

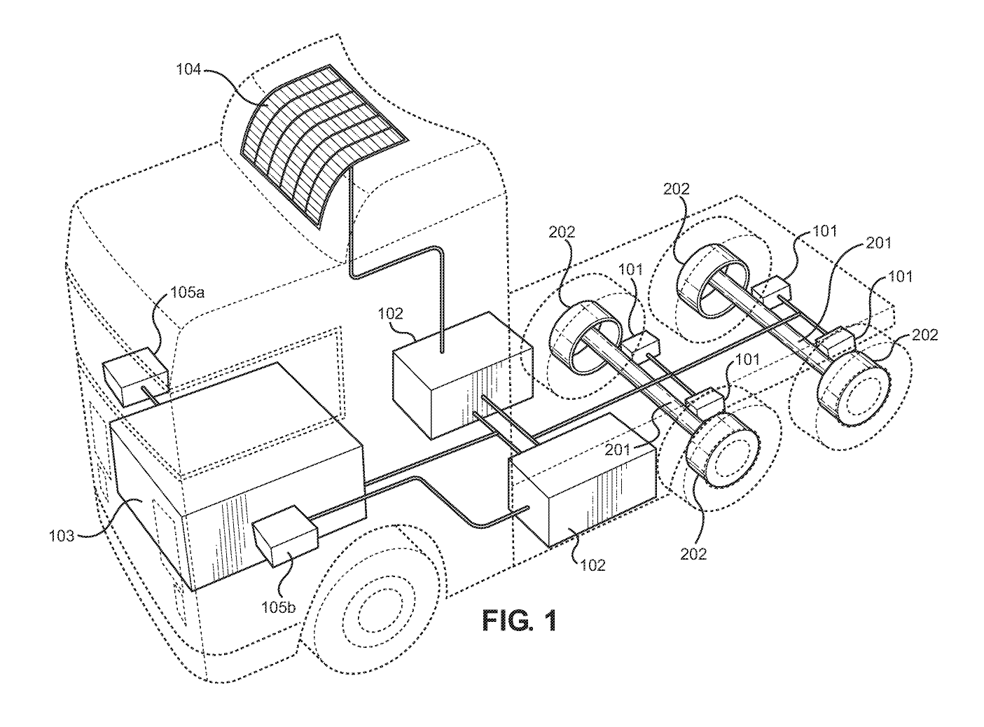

Referring now to FIG. 1, there is shown a diagram of an embodiment of the present electric vehicle. The present electric vehicle utilizes multiple non-fossil fuel energy sources so that the vehicle can operate wholly independently from the direct need for fossil fuels. In an illustrative embodiment, the electric vehicle is a semi-trailer truck; however, the electric vehicle includes any automobile or any other such vehicle. The electric vehicle includes one or more batteries 102 disposed on the vehicle. The batteries 102 are electrically connected to an electrical motor 103 disposed within the vehicle and configured to operably drive the motor 103, which in turn activates the internal combustion engine (not shown) of the vehicle. The electric vehicle further includes a solar panel 104, which is electrically connected to the batteries 102. The solar panel 104 can include an array of any number of photovoltaic cells situated along the exterior of the vehicle. In an illustrative embodiment of the electric vehicle, the solar panel 104 is disposed on the upper surface of the cab of the vehicle.

The electric vehicle includes one or more supplemental non-fossil fuel energy sources configured to harvest additional energy from the standard operation of the vehicle, thereby reducing the amount of energy required directly from the solar panel 104. In an illustrative embodiment, the electric vehicle includes one or more induction generators 101 disposed along the axles 201 and adjacent to the wheels 202 of the vehicle. The induction generators 101 are electrically connected to the batteries 102 and configured to transfer energy thereto for storage. The induction generators 101 are configured to harness the rotational movement of the wheels 202 to generate electricity therefrom, recapturing a portion of the energy generated to place the wheels 202 into motion back into the system.

An illustrative embodiment of the electric vehicle further includes at least one inertial generator 105A, 105B disposed within the vehicle. The at least one inertial generator 105A, 105B is configured to generate electrical energy from the movement of the present vehicle as a whole. The inertial generators 105A, 105B includes vibration-driven, electromagnetic generators that are configured to generate electrical energy from mechanical movement, such as the acceleration of the vehicle, the deceleration of the vehicle, or general vibration of the chassis of the vehicle.

In an illustrative embodiment, the at least one inertial generators 105A, 105B include a first inertial generator 105A that is electrically connected to the motor 103 and a second inertial generator 105B that is electrically connected to the batteries 102. The first inertial generator 105A is configured to directly provide energy to the motor 103, thereby lessening the motor's 103 energy draw on the batteries 102, which in turn lessens the energy loss of the system through heat and other inefficiencies created if the motor 103 indirectly drew electrical energy from the first inertial generator 105A through the batteries 102. The second inertial generator 105B is electrically connected to the batteries 102, allowing the energy generated from the second inertial generator 105B to be utilized by the system as a whole.

In one embodiment of the electric vehicle, the batteries 102 are externally mounted to the lateral sides of the chassis of the vehicle. This arrangement allows the batteries 102 to be quickly and easily replaced as needed by operators. In alternative embodiments of the electric vehicle, the batteries 102 are mounted internally to the vehicle or to the underside of the undercarriage thereof. The batteries 102 can be removably mounted to the chassis via brackets, fasteners, or any other means know in the art.

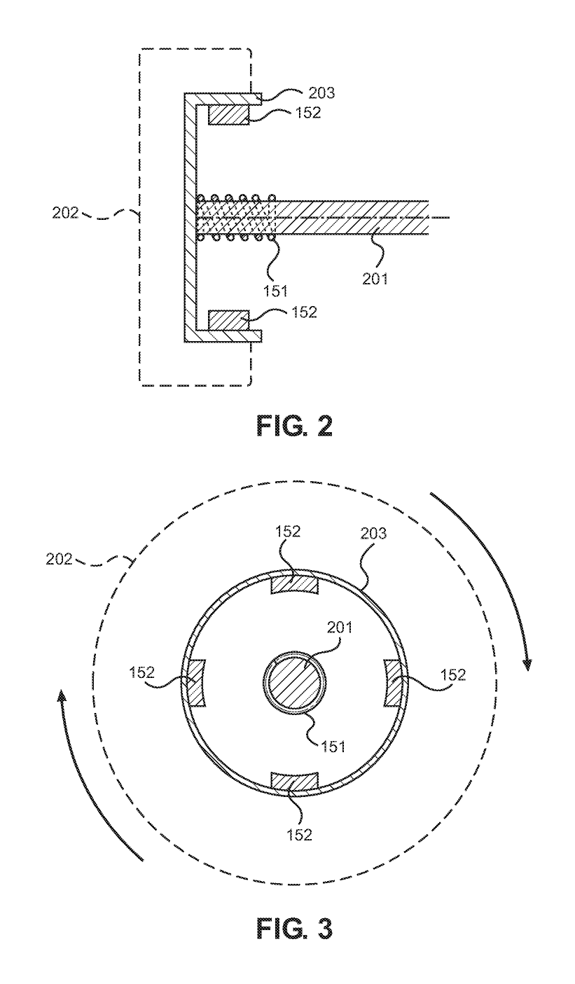

Referring now to FIGS. 2 and 3, there are shown a sectional view and a lateral view of an embodiment of an induction generator of the present electric vehicle. The induction generators disposed at each of the wheels 202 of the vehicle include an induction coil 151 disposed along an axle 201. The induction coil 151 is configured to transmit an electrical current. The induction generators further include a plurality of magnets 152 disposed about the interior perimeter of the wheel hub 203. As the wheel 202 rotates while the vehicle is in motion, the magnets 152 rotate about the induction coil 151 and generate a current therein via electromagnetic induction. Variations in the number and arrangement of the magnets 152 can be utilized to control the generation of electricity within the induction coil 151. The electricity generated in the induction generator is then transmitted to the batteries via electrical wiring for storage therein and utilization by the system.

In one embodiment of the present vehicle, each wheel 202 of the vehicle includes an induction generator. In the depicted embodiment of the induction generator, the induction coil 151 is positioned about the axle 201 of the vehicle; however, in alternative embodiments the induction coil 151 can be positioned adjacently to the axle 201, rather than thereabout. In one embodiment of the induction coil 151, the wheel hub 203 is concentric with the induction coil 151. In one embodiment of the present induction generator, the magnets 152 are evenly spaced about the interior of the wheel hub 203.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An electric vehicle, comprising:
a battery;
a solar cell disposed on an exterior of the vehicle, the solar cell in electrical communication with the battery;
one or more induction generators disposed at one or more wheels of the electric vehicle, the one or more induction generators each including an induction coil and a plurality of magnets disposed about a wheel hub of each of the one or more wheels;
wherein rotation of the plurality of magnets is configured to generate an electrical current in the induction coil;
each of the one or more induction generators in electrical communication with the battery;
an electric motor operably connected to an internal combustion engine, the electrical motor in electrical communication with the battery;
a first inertial generator in direct electrical communication with the electric motor; and
a second inertial generator in electrical communication with the battery.

2) The electric vehicle of claim 1, wherein the one or more induction generators are disposed at each of the one or more wheels.

3) The electric vehicle of claim 1, wherein the battery is removably mounted to an exterior of the electric vehicle.

4) The electric vehicle of claim 1, wherein the electric vehicle is a semi-trailer truck.

5) The electric vehicle of claim 1, wherein the electric vehicle lacks any fossil fuel power sources.

6) The electric vehicle of claim 1, wherein each of the first inertial generator and the second inertial generator includes an electromagnetic generator that is configured to generate electrical energy from mechanical movement.

7) The electric vehicle of claim 1, wherein the induction coil is concentric with the induction coil.
